(19) United States
(12) Patent Application Publication
(10) Pub. No.: US 2015/0298655 A1
(43) Pub. Date: Oct. 22, 2015

(54) SYSTEM FOR PROTECTING A MOTOR VEHICLE

(71) Applicant: RENAULT S.A.S., Boulogne-billancourt (FR)

(72) Inventors: Nicolas MONTHEL, Versailles (FR); Pascal CHEVALIER, Paris (FR); Claude BUZO, Colombes (FR); Olivier SINTES, Clamart (FR)

(73) Assignee: RENAULT S.A.S., Boulogne-billancourt (FR)

(21) Appl. No.: 14/433,772

(22) PCT Filed: Sep. 24, 2013
(86) PCT No.: PCT/FR2013/052217

§ 371 Date: Jun. 23, 2015

(30) Foreign Application Priority Data
Oct. 5, 2012 (FR) 1259499

(51) Int. Cl. B60R 25/24; B60R 25/04; G06Q 50/30; B60R 16/023

(52) U.S. Cl. CPC B60R 25/241; B60R 16/023; B60R 25/04; G06Q 50/30

(57) ABSTRACT

A system for protecting a motor vehicle including an engine, the system including: a remote server transmitting a server authorization order; a system controlling operation of the engine; an unlocking mechanism unlocking the system for controlling operation of the engine; and a communication mechanism fitted in the vehicle and configured to receive the server authorization order and communicate with the unlocking mechanism. The remote server is configured to transmit the authorization order only if it receives a message including a first identification identifying a user and a second identification identifying a vehicle and if the vehicle identified by the second identification can be attributed to the user identified by the first identification.

The technical field of the invention is the protection of a motor vehicle in general and notably the protection of a fleet of shared motor vehicles.

Conventional systems for protecting an individual vehicle include a contact key which suffices to unlock and start the vehicle.

These protection systems are not suitable for shared vehicles for which the protection by means of a key is not sufficient. In fact, the contact key of a shared vehicle is, by definition, not personal and is not kept in a protected location. For example, it is kept in the vehicle's glove compartment, inside the passenger compartment. In this case, if a conventional system for protecting an individual vehicle is used, it suffices to enter the passenger compartment, for example by breaking the window, to start the vehicle.

In current car-sharing systems, it is known to use a relay which is opened to prevent the starting of the vehicle even with the contact key. However, a paper clip is sufficient to break this protection.

A vehicle immobilizer system is known from patent application U.S. Pat. No. 6,618,650, comprising an identification card reader located in the passenger compartment and a means of identifying the vehicle to a car-sharing server in order to determine whether the customer is in fact the legitimate customer for the vehicle. This system controls the starting only if the customer identification condition is satisfied and if the key in the card reader matches, and if one of these two conditions is not satisfied, the vehicle does not start.

One of the disadvantages of this system is that it requires a recognition of the identity of the customer by a physical medium. The recognition by a physical medium in fact incurs a cost linked to the recognition system of the physical medium in the vehicle. This recognition also entails a prior transmission of the physical medium and a functional (not damaged) and present (not forgotten) physical medium.

Moreover, according to patent application U.S. Pat. No. 6,618,650, the recognition requires a communication in the uplink direction from the vehicle to the car-sharing server then in the downlink direction from the car-sharing server to the vehicle. This round trip can take some time.

Moreover, in the case where there is a wish to do without the car-sharing server and check whether the user identified by means of the physical medium is authorized to use the vehicle in a processing means including a database located in the vehicle, it is probable that this infringes legal obligations to authorities regulating privacy and data protection such as the CNIL (Commission nationale de l'informatique et des libertés) [French Data Protection Authority] in France, for example.

The invention aims to overcome the problems of the prior art mentioned above.

According to a first aspect, the subject matter of the invention is a system for protecting a motor vehicle equipped with an engine including:
a remote server to transmit a server authorization command;
an engine operation control system suitable for managing the immobilizer;
means for unlocking the engine operation control system; and
communication means fitted in the vehicle, configured to receive said server authorization command and communicate with the unlocking means.

According to a general characteristic, the remote server is configured to transmit the authorization command only if it receives a message including a first identification means to identify the user and a second identification means to identify a vehicle and if the vehicle identified by the second identification means is attributable to the user identified by the first identification means.

The identification of the user and the vehicle is thus carried out by the remote server, thereby avoiding the transmission problems of a physical identification medium mentioned above in the prior art, thereby also avoiding the need for a reader in the vehicle. Moreover, the identification of the user and the vehicle on the one hand and the reception of the server authorization command can be effected before the user enters the vehicle. The user does not therefore need to wait in the vehicle for the round trip between the remote server and the vehicle. The determination of the attributable character of a vehicle to a user may, for example, be carried out using a database according to which a vehicle is assigned to the user. The attributable character may also be determined according to a classification of the user on one hand and the vehicle on the other hand, in which case their two classifications must match so that the vehicle is attributable to the user.

Moreover, the protection system may be integrated into the existing immobilizer chain, no weak link then being added.

According to one embodiment, the remote server is configured to receive vehicle hire requests from users in order to enable an allocation of vehicles to users according to these requests.

In a first embodiment, the database is managed directly by the remote server which allocates vehicles to users according to requests. This is advantageous since it allows a reactivity and a limitation in the number of devices. In a second embodiment, the remote server must manage a large number of actions (message transmission and reception) and it may be beneficial to delegate the management of the database to a dedicated server. In this case, the remote server communicates with this dedicated server in order to instigate the allocation by the dedicated server of vehicles to users according to requests.

According to one characteristic, the remote server is configured to transmit the authorization command if, at the time of reception of the message, the vehicle identified by the second identification means is assigned to the user identified by the first identification means.

The remote server thus allows the use of a vehicle only if the identified vehicle has already been assigned to the identified user.

According to one embodiment, the message is transmitted by means of the cellphone of the user, the first identification means being the telephone number of the cellphone of the user and the second identification means being an identification number of the vehicle or a photo of a part of the vehicle.

This solution is therefore very simple to implement. The user's telephone number is a reliable datum since the user's cellphone is a personal item.

According to one characteristic, the communication means fitted in the vehicle are configured to transmit, following the reception of said server authorization command, an unlocking command to said unlocking means, the unlocking means being configured to send a protection deactivation command to the control system only if they receive the unlocking command.

The engine control system generally includes a software lock that can be deactivated with the protection deactivation command. The unlocking means can thus control the starting of the engine by means of this protection deactivation command. The unlocking means can be configured to transmit the protection deactivation command only if a plurality of cumulative conditions are implemented, including the reception of the unlocking command.

According to one embodiment, the unlocking means of the control system are configured to unlock the passenger compartment of the vehicle when they receive the unlocking command.

The user can thus enter the vehicle following the identification by the remote server of the user and the vehicle to be hired.

According to one embodiment, the remote server can be authenticated to the unlocking means, the unlocking means being configured to send the protection deactivation command to the control system only if the remote server is authenticated.

Increased security is obtained by means of the authentication, since the situation is avoided according to which a hacker passes himself off as the remote server to the unlocking means.

According to one embodiment, in order to authenticate the remote server to the unlocking means, the remote server is authenticated to the communication means then the communication means are authenticated to the unlocking means.

A chain of trust going from the remote server to the unlocking means is thus obtained.

According to one embodiment, the unlocking means are authenticated to the engine control system.

This authentication makes it possible to further increase security since the situation is avoided according to which an unauthorized user could attempt to deactivate the software lock using a computer connected to the engine control system.

According to one embodiment, the system includes means for detecting an authenticated key configured to transmit a key authorization command and in which the unlocking means are configured to send the protection deactivation command to the control system only if they receive the key authorization command.

The protection system thus enables a protection in addition and cumulative to the protection using the key. By adapting the unlocking system and by adding the communication means, the protection system is integrated into the existing immobilizer chain, with no weak link being added.

The remote server can advantageously be configured to transmit the authorization command only if it receives the message from the user. The message may be transmitted by the user from communication means such as a terminal, an electronic key, or a cellphone.

According to one embodiment, at least one of the messages is encrypted in the set including the message from the user, the server authorization command, the unlocking command, the key authorization command and the protection deactivation command.

Eavesdropping is thus avoided and security is increased.

According to another aspect, the subject matter of the invention is a method for protecting a motor vehicle equipped with an engine including:
a step of transmitting a server authorization command transmitted by a remote server;
a step of receiving the server authorization command within the vehicle, followed by a communication to unlock the engine control system.

According to one general characteristic, the method furthermore includes a step of transmission by the user of a message including a first identification means to identify the user and a second identification means to identify a vehicle, the step of transmitting the authorization command being carried out only if the remote server receives said message including the two identification means and if the vehicle identified by the second identification means is attributable to the user identified by the first identification means.

Other characteristics and advantages of the invention will become evident from the examination of the detailed description of one, non-limiting, embodiment and the attached drawings, in which:

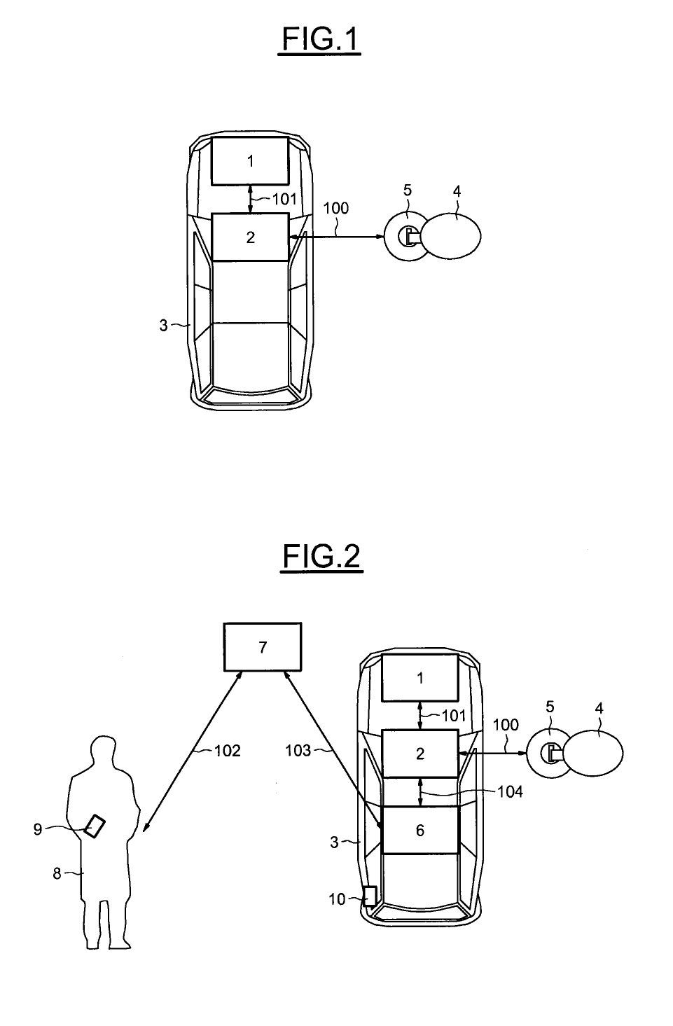

FIG. 1 shows schematically a system for protecting an individual vehicle;

FIG. 2 shows a protection system according to the invention;

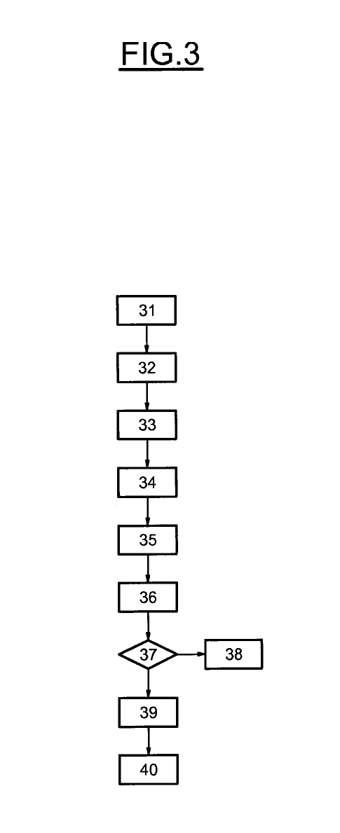

FIG. 3 shows, according to one embodiment, all of the steps of a method for protecting a vehicle according to the invention;

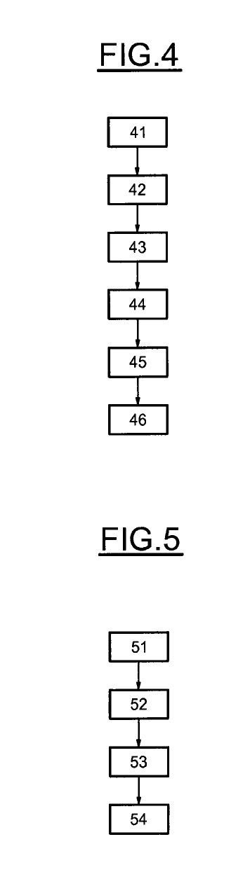

FIG. 4 shows, according to one embodiment, all of the steps of a method for identifying a user according to the invention; and

FIG. 5 shows, according to one embodiment, all of the steps of an authentication method according to the invention.

FIG. 1 shows a motor vehicle 3, including an engine and a system 1 to control the operation of this engine. For example, in the case of a combustion engine, the operation control system notably manages the injection of fuel into the combustion engine.

The vehicle 3 also includes a vehicle unlocking system 2. This unlocking system is a means for determining conditions for starting. It communicates with a software lock which is fitted in the engine operation control system 1 and which may, for example, block the injection of fuel into the combustion engine. The unlocking system may also be fitted in a known manner in the operation control system. The vehicle unlocking system 2 is also capable of opening or closing the passenger compartment of the vehicle 3.

The vehicle 3 also includes an electronic key protection device 5. This device 5 includes a starting contactor which receives a contact key 4.

According to one known embodiment, following its insertion into the starting contactor, the turning of the key enables the electrical power supply of an engine starter. The starting contactor thus forms a mechanical lock which, if the key cannot be inserted and turned in the starting contactor, prevents the starter power supply. However, according to one variant (not shown), a so-called “hands-free” opening and closing system known to the person skilled in the art may replace the traditional key system described in this embodiment.

The contact key furthermore includes a coded electronic system which allows a key code to be transmitted. The electronic protection device 5 is capable of receiving the key code by means a ring wrapped around the starting contactor, and of transmitting a key authorization command 100 to the vehicle unlocking system. The key authorization command is transmitted only if the electronic protection device 5 recognizes the key code.

When the vehicle unlocking system 2 receives the key authorization command, it transmits a protection deactivation command 101 which is received by the engine operation control system 1. The software lock is then unblocked. For example, while the software lock is blocked, the injection of fuel into the engine is impossible and the starting of the engine is therefore impossible even if the starter is powered. The software lock therefore acts in addition to the mechanical lock. It thus appears, according to the protection method shown in FIG. 1, that the contact key suffices to unblock and start the vehicle.

FIG. 2 shows a vehicle protection system 3 according to the invention. This protection system is particularly suitable for a shared vehicle used on a hire basis. More generally, it is suitable for any vehicle for which the protection by means of a contact key is considered to be inadequate.

In addition to the vehicle 3, the key 4 and the electronic protection device 5, which are similar to those shown in FIG. 1, FIG. 2 shows a user 8 provided with a cellphone 9, a remote server 7, a vehicle identification means 10, communication means 6 and a vehicle unlocking system 2.

According to the invention, the vehicle unlocking system 2 sends a protection deactivation command 101 when it receives the key authorization command 100 and also an unlocking command 104 from the communication means 6. The unlocking system 2 is also configured to open the passenger compartment of the vehicle when it receives the unlocking command 104, and to communicate with the software lock fitted in the engine control system. The unlocking system 2 is a means of determining the conditions for starting, but, according to the invention, these conditions are summarized on reception of two commands, i.e. the unlocking command 104 transmitted by the communication means 6 on reception of an authorization command 103 supplied by the server 7, and the key authorization command 100. These two commands may be encrypted in order to improve the security of the system. The vehicle unlocking system 2 does not therefore include user identification means or vehicle identification means.

The communication means 6 are configured to communicate with the remote server 7, preferably using a wireless communication channel, and to communicate with the unlocking system 2. The communication means 6 include a vehicle-sharing calculator which transmits the unlocking command 104 when it receives a server authorization command 103 from the remote server 7. The communication means 6 do not include user identification means or vehicle identification means either. The user identification and the determination that the user is duly authorized to use the vehicle for a given time are in fact carried out by the remote server 7 via the identification of the key. The identification of the key in the cylinder instigates an engine operation control system authorization request to the communication means 6. If the protection device recognizes the key, it then transmits the key authorization command 100 which results in the dispatch of the protection deactivation command 101 by the unlocking system 2 and the unblocking of the software lock in the engine control system 1. When the user turns the key, the starter is powered and the engine starts due to the unblocking of the software lock.

The remote server 7 is advantageously authenticated to the communication means 6 and the communication means 6 are authenticated to the unlocking system 2.

These authentications are advantageously carried out in the following order: the remote server 7 is authenticated to the communication means 6 then the communication means 6 are authenticated to the unlocking system 2. A chain of trust is thus obtained. The authentication of the remote server 7 to the communication means 6 followed by the authentication of the communication means 6 to the unlocking system 2 thus corresponds to an authentication of the remote server to the unlocking system 2. An authentication of the unlocking system 2 to the engine control system 1 can also be provided.

In the embodiment shown in FIG. 2, the authorization command 103 is transmitted by the remote server 7 to the communication means 6 once it has received a secure message 102 from the user 8 via the cellphone 9. To do this, for example, the user 8 copies an identifier of the identification means 10 of the vehicle, via a photograph or manually, and transmits it in the secure message 102 to the remote server 7. The remote server 7 then determines, from the secure message 102, whether it can send the authorization command 103 for this user and this vehicle at the given time by referring to the reservation of the user 8.

The invention also applies when the authorization command 103 is transmitted automatically by the remote server 7 following the reception of a secure message relating to the vehicle reservation.

All these authentications can be carried out using a conventional encryption method which makes it possible to authenticate the user who has hired the vehicle.

For example, the remote server 7 sends its signature to the communication means 6 following an authentication request from the communication means 6 sent to the remote server 7, the communication means 6 send their signature from the unlocking system 2 following an authentication request from the unlocking system 2 sent to the communication means 6 and the unlocking system 2 sends its signature to the engine control system 1 following an authentication request from the engine control system 1 sent to the unlocking system 2.

It can also be provided that the signature is added to the server authorization command 103 and the unlocking command 104.

In this case, the server authorization command 103 and the unlocking command 104 are sent following the authentication requests from the communication means 6 and the unlocking system 2 respectively.

It can also be provided that the exchanges between the engine control system 1 and the unlocking system 2, between the unlocking system 2 and the electronic protection device 5, between the unlocking system 2 and the communication means and between the communication means the remote server are encrypted.

The person skilled in the art will be able to use, for example, an asymmetric (public, private) key system, or any other encrypted key system, such as, for example, a symmetric key, in order to encrypt these exchanges and generate the signatures.

FIG. 3 shows a protection method including 9 steps, numbered 31 to 39.

Step 31 is a vehicle reservation step. Step 32 is a step of presentation of the customer in front of the vehicle that he has reserved.

Step 33 is a step of identifying the user and the vehicle. This step is carried out after the user has presented himself in front of the vehicle to be hired. Step 33 is described in detail below in FIG. 4.

Step 34 is a step of opening the passenger compartment of the vehicle. In fact, at the end of step 33, an unlocking command 104 is sent to the unlocking system 2 of the vehicle. Following this command 104, the unlocking system 2 controls the opening of the passenger compartment of the vehicle 3.

Step 35 is a step of authenticating the unlocking system 2 to the engine operation control system 1. During step 35, the unlocking system 2 sends an authentication material (a signature, for example) to the engine control system 1 following an authentication request from the engine control system 1 sent to the unlocking system 2. At the end of this step 35, the unlocking system 2 is authenticated to the control system 1.

Step 36 is a step of authenticating the remote server 7 to the unlocking system 2. Step 36 is described in detail below in FIG. 5.

Step 37 is a step of checking the authentication of the remote server 7. If the remote server 7 is authenticated by the unlocking system 2, the method continues with step 39. If not, the method is interrupted with the end step 38.

Step 39 is a step of authenticating the key 4. During this step, the protection device 5 detects whether the key 4 is authentic. Following this detection, the device 5 sends a key authorization command 100.

Step 40 is a “deprotection” step during which the unlocking system 2 sends a protection deactivation command 101 to the engine control system 1. This command 101 causes the opening of the software lock.

FIG. 4 shows in detail step 33 from FIG. 3.

The user and vehicle identification step 33 includes steps 41 to 46.

Step 41 is a step of dispatch of a message by the user 8 using his cellphone 9. This message includes a user identification means (for example the user's telephone number appearing in the message) and a vehicle identification means (for example a number). For example, the message is sent by the user to a telephone number dedicated to the hire service. The message is then forwarded via the mobile network to arrive at the server identified by this telephone number. This server may be the remote server 7 or a communication server which then relays this message to the remote server 7.

Step 42 is a step of reception of this message by the remote server 7.

Step 43 is a step of checking the vehicle and user identification means. For this purpose, the remote server consults the reservations database. If, at the time when the message is received, the identified vehicle is allocated to the user identified in the reservations database, the method continues with step 44.

Step 44 is a step of sending a server authorization command 103.

Step 45 is a step of reception and transmission by the communication means 6. On reception of the server authorization command 103, the communication means 6 transmit the unlocking command 104.

Step 46 is a step of reception of the unlocking command 104 by the unlocking system 2.

FIG. 5 shows in detail step 36 from FIG. 3.

The authentication step 36 includes steps 51 to 54.

Step 51 is a step comprising an authentication request sent from the unlocking system 2 to the communication means 6.

Step 52 is a step comprising an authentication request sent from the communication means 6 to the remote server 7.

Step 53 is a step of dispatch of an authentication material by the remote server 7 to the communication means 6. At the end of this step, the remote server 7 is authenticated to the communication means 6.

Step 54 is a step of dispatch of an authentication material by the communication means 6 to the unlocking system 2. At the end of this step, the communication means 6 are authenticated to the unlocking system 2. The chain of trust thus extends from the unlocking system 2 to the remote server 7. The remote server 7 is thus authenticated to the unlocking system 2. In the case where step 35 is carried out, the chain of trust extends from the engine operation control system to the remote server 7.

In the case where the material for authenticating the remote server 7 or the communication means 6 is a signature sent in the server authorization command 103 or the unlocking command 104. The steps of sending the message 44 (server authorization command 103) and 45 (unlocking command 104) enable the authentications of steps 53 and 54 respectively. In this case, the authentication requests 51 and 52 should therefore take place before step 44 and step 45 respectively.

1-13. (canceled)

14. A system for protecting a motor vehicle including an engine, the system comprising:
a remote server to transmit a server authorization command;
an engine operation control system;
means for unlocking the engine operation control system; and
communication means fitted in the vehicle, configured to receive the server authorization command and communicate with the unlocking means;
wherein the remote server is configured to transmit the authorization command only if it receives a message including a first identification means to identify a user and a second identification means to identify a vehicle and if the vehicle identified by the second identification means is attributable to the user identified by the first identification means.

15. The system as claimed in claim 14, wherein the remote server is configured to receive vehicle hire requests from users to enable an allocation of vehicles to users according to the requests.

16. The system as claimed in claim 15, wherein the remote server is configured to transmit the authorization command if, at a time of reception of the message, the vehicle identified by the second identification means is assigned to the user identified by the first identification means.

17. The system as claimed in claim 14, wherein the message is transmitted by a cellphone of the user, the first identification means being a telephone number of the cellphone of the user and the second identification means being an identification number of the vehicle or a photo of a part of the vehicle.

18. The system as claimed in claim 14, wherein the communication means fitted in the vehicle is configured to transmit, following reception of the server authorization command, an unlocking command to the unlocking means, the unlocking means being configured to send a protection deactivation command to the control system only if it receives the unlocking command.

19. The system as claimed in claim 18, wherein the unlocking means of the control system is configured to unlock the passenger compartment of the vehicle when it receives the unlocking command.

20. The system as claimed in claim 14, wherein the remote server can be authenticated to the unlocking means, the unlocking means being configured to send the protection deactivation command to the control system only if the remote server is authenticated.

21. The system as claimed in claim 14, wherein, to authenticate the remote server to the unlocking means, the remote server is authenticated to the communication means, then the communication means is authenticated to the unlocking means.

22. The system as claimed in claim 14, wherein the unlocking means is authenticated to the engine control system.

23. The system as claimed in claim 14, further comprising means for detecting an authenticated key configured to transmit a key authorization command and in which the unlocking means is configured to send a protection deactivation command to the control system only if it receives the key authorization command.

24. The system as claimed in claim 18, wherein at least one of the messages is encrypted in the set including the message from the user, the server authorization command, the unlocking command, the key authorization command, and the protection deactivation command.

25. The system as claimed in claim 14, wherein the remote server is configured to transmit the authorization command only if it receives the message from the user.

26. A method for protecting a motor vehicle including an engine, the method comprising:
transmitting a server authorization command transmitted by a remote server;
receiving the server authorization command within the vehicle, followed by a communication to unlock the engine control system;
transmitting by a user a message including a first identification means to identify the user and a second identification means to identify a vehicle;
wherein the transmitting the authorization command being carried out only if the remote server receives the message including the two identification means and if the vehicle identified by the second identification means is attributable to the user identified by the first identification means.
